(19) United States
(12) Patent Application Publication
(10) Pub. No.: US 2007/0288980 A1
(43) Pub. Date: Dec. 13, 2007

(54) System and method for digital communication having a frame format and parsing scheme with parallel convolutional encoders

(76) Inventors: Huaning Niu, Sunnyvale, CA (US); Pengfei Xia, Mountain View, CA (US); Chiu Ngo, San Francisco, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/724,735

(22) Filed: Mar. 15, 2007

Related U.S. Application Data
(60) Provisional application No. 60/812,498, filed on Jun. 8, 2006.

(51) Int. Cl. H04N 7/173

(52) U.S. Cl. 725/123

(57) ABSTRACT

A method of processing high definition video data to be transmitted over a wireless medium is disclosed. In one embodiment, the method includes communicating a data frame having a format of: i) a packet header, ii) a medium access control (MAC) protocol data unit (MPDU) portion, wherein the MPDU portion includes a plurality of transmit data units (TDUs), wherein each TDU includes only uncompressed video data unit, and iii) a plurality of tail bits separately located from the MPDU portion. Another embodiment provides a group parser which allows for efficient convolutional encoding of the WiHD video data. According to at least one embodiment, the system provides the high transmission efficiency of the WiHD video data.

### CROSS-REFERENCE TO RELATED APPLICATIONS

This application claims priority under 35 U.S.C. §119(e) from provisional application No. 60/812,498 filed on Jun. 8, 2006, which is hereby incorporated by reference. This application also relates to U.S. patent application (Attorney Docket Number: SAMINF.041A) entitled “System and method for digital communication having puncture cycle based multiplexing scheme with unequal error protection (UEP)” and U.S. patent application (Attorney Docket Number: SAMINF.045A) entitled “System and method for digital communication using multiple parallel encoders,” concurrently filed as this application, which are incorporated by reference.

### BACKGROUND OF THE INVENTION

1. Field of the Invention

The present invention relates to wireless transmission of video information, and in particular, to transmission of uncompressed high definition video information over wireless channels.

2. Description of the Related Technology

With the proliferation of high quality video, an increasing number of electronic devices, such as consumer electronic devices, utilize high definition (HD) video which can require multi-Gbps (bits per second) in bandwidth for transmission. As such, when transmitting such HD video between devices, conventional transmission approaches compress the HD video to a fraction of its size to lower the required transmission bandwidth. The compressed video is then decompressed for consumption. However, with each compression and subsequent decompression of the video data, some data can be lost and the picture quality can be reduced.

The High-Definition Multimedia Interface (HDMI) specification allows transfer of uncompressed HD signals between devices via a cable. While consumer electronics makers are beginning to offer HDMI-compatible equipment, there is not yet a suitable wireless (e.g., radio frequency) technology that is capable of transmitting uncompressed HD video signals. Wireless local area network (WLAN) and similar technologies can suffer interference issues when several devices are connected which do not have the bandwidth to carry the uncompressed HD signals.

### SUMMARY OF CERTAIN INVENTIVE ASPECTS

One aspect of the invention provides a system for processing wireless high definition video data to be transmitted over a wireless medium, the system comprising i) a parser configured to parse a received video data stream into a plurality of sub video data streams, ii) a plurality of encoders configured to encode in parallel the plurality of sub video data streams so as to create a plurality of encoded data streams and iii) a multiplexer configured to multiplex the plurality of encoded data streams so as to create a multiplexed data stream, wherein the multiplexed data stream is transmitted over the wireless medium, and then received and decoded at the receiver.

Another aspect of the invention provides a method of processing wireless high definition video data to be transmitted over a wireless medium, comprising: i) receiving a video data stream, ii) parsing the video stream into a plurality of sub video data streams, iii) convolutional encoding in parallel the plurality of sub video streams so as to create a plurality of encoded data streams and iv) multiplexing the plurality of encoded data streams so as to create a multiplexed data stream, wherein the multiplexed data stream is transmitted over the wireless medium, and then received and decoded at the receiver.

Another aspect of the invention provides one or more processor-readable storage devices having processor-readable code embodied on the processor-readable storage devices, the processor-readable code for programming one or more processors to perform a method of processing wireless high definition video data to be transmitted over a wireless medium, the method comprising: i) receiving a video data stream, ii) parsing the video stream into a plurality of sub video data streams, iii) convolutional encoding in parallel the plurality of sub video streams so as to create a plurality of encoded data streams and iv) multiplexing the plurality of encoded data streams so as to create a multiplexed data stream, wherein the multiplexed data stream is transmitted the wireless medium, and then received and decoded at the receiver.

Still another aspect of the invention provides a method of processing wireless high definition video data to be transmitted over a wireless medium, comprising: communicating a data frame having a format of: i) a packet header, ii) a medium access control (MAC) protocol data unit (MPDU) portion, wherein the MPDU portion includes a plurality of transmit data units (TDUs), wherein each TDU includes only uncompressed video data unit and iii) a plurality of tail bits separately located from the MPDU portion.

### BRIEF DESCRIPTION OF THE DRAWINGS

FIG. 1 is a functional block diagram of a wireless network that implements uncompressed HD video transmission between wireless devices according to one embodiment.

FIG. 2 is a functional block diagram of an example communication system for transmission of uncompressed HD video over a wireless medium, according to one embodiment.

FIG. 3 illustrates a data format of a typical wireless HD video frame.

FIG. 4 illustrates a data format of a wireless HD video frame according to one embodiment of the invention.

FIG. 5 illustrates an exemplary wireless HD video transmitter system according to one embodiment of the invention.

FIG. 6 illustrates a conceptual diagram for explaining a wireless HD video transmitting procedure according to one embodiment of the invention.

FIG. 7 illustrates a conceptual diagram for explaining a wireless HD video transmitting procedure according to another embodiment of the invention.

FIG. 8 illustrates an exemplary flowchart which shows a wireless HD video transmitting procedure according to one embodiment of the invention.

### DETAILED DESCRIPTION OF CERTAIN INVENTIVE EMBODIMENTS

Certain embodiments provide a method and system for transmission of uncompressed HD video information from a sender to a receiver over wireless channels.

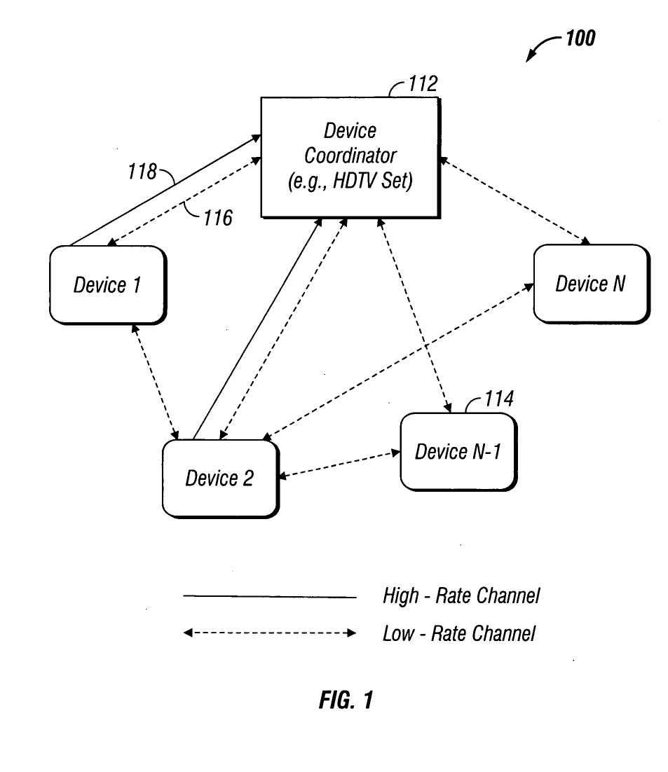

Example implementations of the embodiments in a wireless high definition (HD) audio/video (A/V) system will now be described. FIG. 1 shows a functional block diagram of a wireless network 100 that implements uncompressed HD video transmission between A/V devices such as an A/V device coordinator and A/V stations, according to certain embodiments. In other embodiments, one or more of the devices can be a computer, such as a personal computer (PC). The network 100 includes a device coordinator 112 and multiple A/V stations 114 (e.g., Device 1 . . . Device N). The A/V stations 114 utilize a low-rate (LR) wireless channel 116 (dashed lines in FIG. 1), and may use a high-rate (HR) channel 118 (heavy solid lines in FIG. 1), for communication between any of the devices. The device coordinator 112 uses a low-rate channel 116 and a high-rate wireless channel 118, for communication with the stations 114.

Each station 114 uses the low-rate channel 116 for communications with other stations 114. The high-rate channel 118 supports single direction unicast transmission over directional beams established by beamforming, with e.g., multi-Gb/s bandwidth, to support uncompressed HD video transmission. For example, a set-top box can transmit uncompressed video to a HD television (HDTV) over the high-rate channel 118. The low-rate channel 116 can support bi-directional transmission, e.g., with up to 40 Mbps throughput in certain embodiments. The low-rate channel 116 is mainly used to transmit control frames such as acknowledgement (ACK) frames. For example, the low-rate channel 116 can transmit an acknowledgement from the HDTV to the set-top box. It is also possible that some low-rate data like audio and compressed video can be transmitted on the low-rate channel between two devices directly. Time division duplexing (TDD) is applied to the high-rate and low-rate channel. At any one time, the low-rate and high-rate channels cannot be used in parallel for transmission, in certain embodiments. Beamforming technology can be used in both low-rate and high-rate channels. The low-rate channels can also support omni-directional transmissions.

In one example, the device coordinator 112 is a receiver of video information (hereinafter “receiver 112”), and the station 114 is a sender of the video information (hereinafter “sender 114”). For example, the receiver 112 can be a sink of video and/or audio data implemented, such as, in an HDTV set in a home wireless network environment which is a type of WLAN. In another embodiment, the receiver 112 may be a projector. The sender 114 can be a source of uncompressed video or audio. Examples of the sender 114 include a set-top box, a DVD player or recorder, digital camera, camcorder, other computing device (e.g., laptop, desktop, PDA, etc.), and so forth.

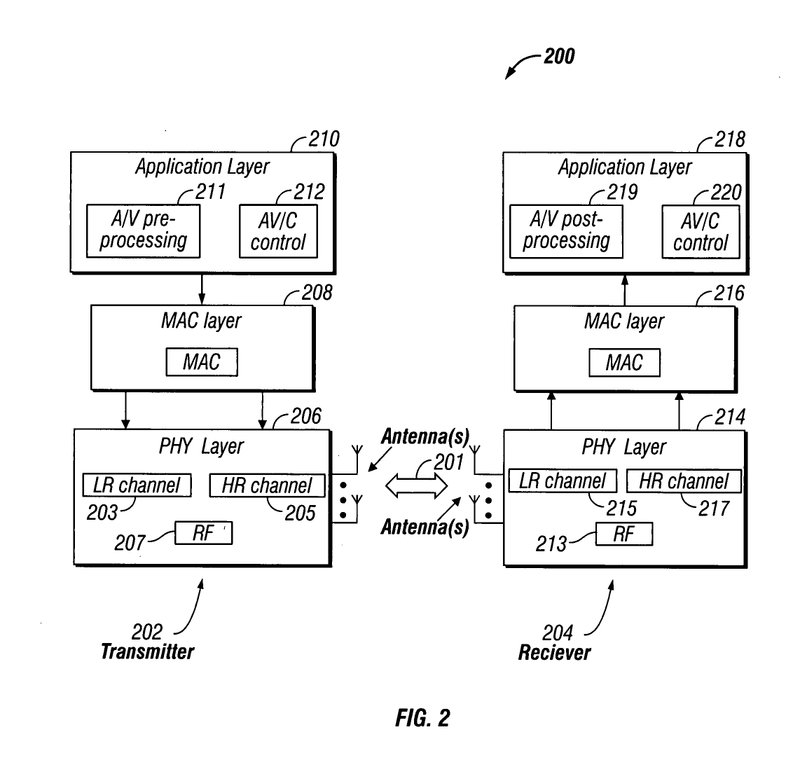

FIG. 2 illustrates a functional block diagram of an example communication system 200. The system 200 includes a wireless transmitter 202 and wireless receiver 204. The transmitter 202 includes a physical (PHY) layer 206, a media access control (MAC) layer 208 and an application layer 210. Similarly, the receiver 204 includes a PHY layer 214, a MAC layer 216, and an application layer 218. The PHY layers provide wireless communication between the transmitter 202 and the receiver 204 via one or more antennas through a wireless medium 201.

The application layer 210 of the transmitter 202 includes an A/V pre-processing module 211 and an audio video control (AV/C) module 212. The A/V pre-processing module 211 can perform pre-processing of the audio/video such as partitioning of uncompressed video. The AV/C module 212 provides a standard way to exchange A/V capability information. Before a connection begins, the AV/C module negotiates the A/V formats to be used, and when the need for the connection is completed, AV/C commands are used to stop the connection.

In the transmitter 202, the PHY layer 206 includes a low-rate (LR) channel 203 and a high rate (HR) channel 205 that are used to communicate with the MAC layer 208 and with a radio frequency (RF) module 207. In certain embodiments, the MAC layer 208 can include a packetization module (not shown). The PHY/MAC layers of the transmitter 202 add PHY and MAC headers to packets and transmit the packets to the receiver 204 over the wireless channel 201.

In the wireless receiver 204, the PHY/MAC layers 214, 216, process the received packets. The PHY layer 214 includes a RF module 213 connected to the one or more antennas. A LR channel 215 and a HR channel 217 are used to communicate with the MAC layer 216 and with the RF module 213. The application layer 218 of the receiver 204 includes an A/V post-processing module 219 and an AV/C module 220. The module 219 can perform an inverse processing method of the module 211 to regenerate the uncompressed video, for example. The AV/C module 220 operates in a complementary way with the AV/C module 212 of the transmitter 202.

In order to improve the video quality and combat the effect of wireless-fading channel, the idea of priority encoding transmission is applied to wireless HD (WiHD), which assigns varying degrees of forward error correction (FEC) to different parts of the video bits stream depending upon their relative importance. For example, the most significant bit (MSB) of the uncompressed video may be provided with better protection than the least significant bit (LSB). Another requirement of WiHD is the fast digital signal processing speed, e.g., at a “Giga bits per second” data rate. However, this high processing speed is very challenging for a FEC decoder. In one embodiment, multiple FEC decoders which are operated in parallel are needed.

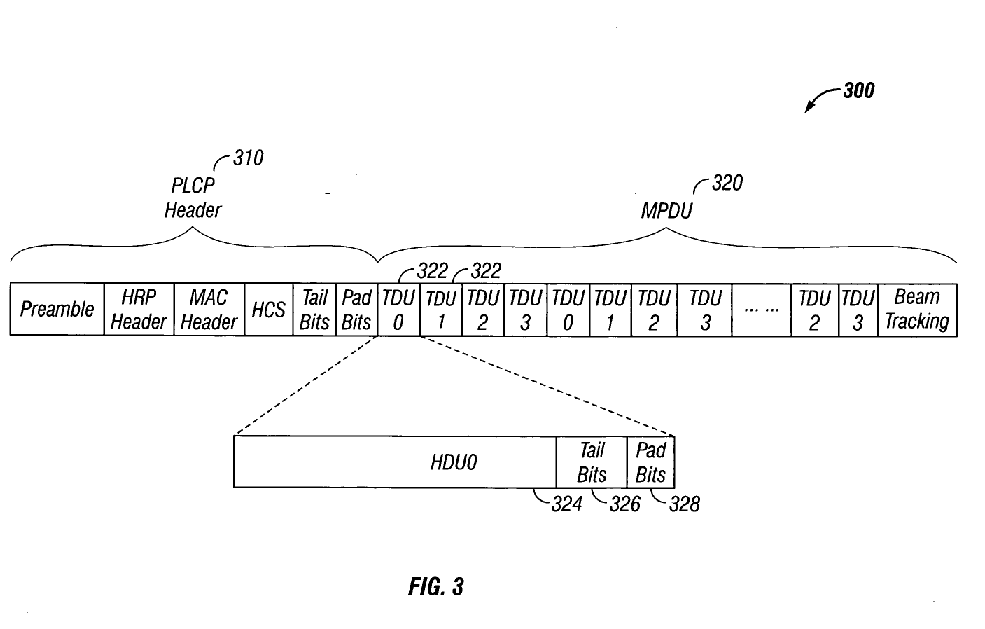

FIG. 3 illustrates a data format of a typical wireless HD video frame. The format 300 includes a PLCP (Physical Layer Convergence Protocol) header 310 and an MAC protocol data unit (MPDU) 320. The PLCP header 310 includes a preamble, a physical layer header (HRP header), an MAC header, a HCS (header check-sum), tail bits and pad bits for header. The MPDU 320 includes a number of (normally a few hundreds) transmit data units (TDUs) 322. Each TDU 322 includes a data portion (HDU) 324, tail bits 326 and pad bits 328. In one embodiment, a description regarding a data format of an exemplary wireless HD video frame is provided in “WirelessHD Specification Revision 0.1,” Jul. 12, 2006, which is incorporated herein by reference.

One drawback of the above data format is that since tail bits and pad bits are included in each TDU 322, it increases the overhead and reduces the transmission efficiency. Another drawback is that there may be a long delay with parallel decoding, at a receiver site, which may not fit in the interframe separation (IFS) decoding budget provided by communication standard.

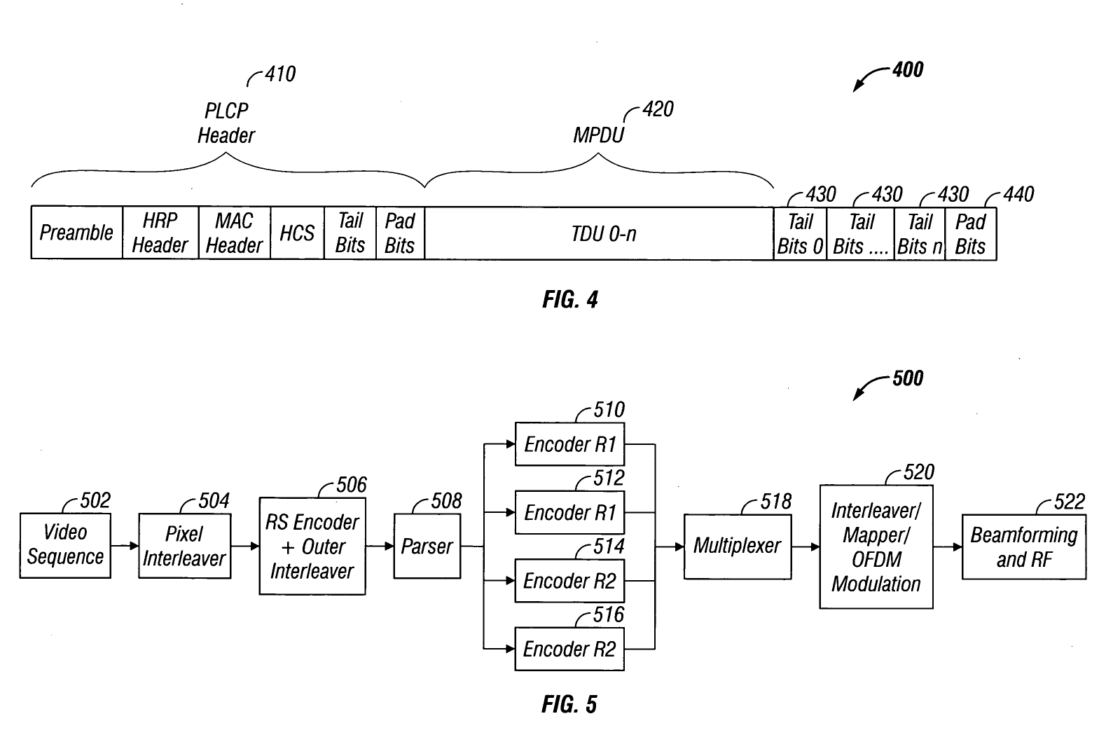

FIG. 4 illustrates a data format 400 of a wireless HD video frame according to one embodiment of the invention. The format 400 includes a PLCP header 410, an MPDU 420, tail bits 430 and pad bits 440. The MPDU 420 includes TDU 0-TDU n. In one embodiment, each TDU includes neither tail bits nor pad bits. In one embodiment, “n” is predetermined number (e.g., 16). “n” is the number of parallel encoders used in the system. The tail bits 430 for each TDU are inserted after the MPDU 420. The pad bits 440 are added at the end of the packet 400 to make an integer number of orthogonal frequency division multiplexing (OFDM) symbols. Since the tail bits 430 are added at the end of the packet 400 and not included in the TDUs, it can enhance transmission efficiency.

For example, in the typical data format as shown in FIG. 3, tail bits and pad bits are included in each and every TDU 322. Generally, as there are several hundred TDUs, the same number (several hundreds) of tail bits and pad bits are needed in the FIG. 3 format. This significantly increases the overhead and reduces the transmission efficiency. On the contrary, in the FIG. 4 embodiment, instead of including the tail bits 430 and pad bits 440 in every TDU, those bits 430 and 440 are inserted at the end of the packet 400 as shown in FIG. 4. Generally, the predetermined number “n” is significantly less (e.g., 16) than several hundreds. The number of tail bits is determined by the chosen code and the number of parallel encoders “n”. For example, if the chosen convolutional code needs 6 tail bits, then a total of 6n zeros are inserted as tail bits. Thus, the communication overhead at a transmitter is substantially reduced. Furthermore, since less information is transmitted to a receiver, decoding delay at the receiver also significantly decreases.

In one embodiment, the frame as shown in FIG. 4 is created (assembled) in the MAC layer 208 (see FIG. 2). This format enables fast parallel convolutional decoding without incurring large decoding delay, given efficient parallel encoding is implemented at the transmitter.

FIG. 5 illustrates an exemplary wireless HD video transmitter system according to one embodiment of the invention. The system 500 includes a video sequence 502, a pixel interleaver 504, a Reed Solomon (RS) encoder/outer interleaver 506, a parser 508, a plurality of encoders 510-516, a multiplexer 518, an interleaver/mapper/OFDM modulation 520 and a beamforming and RF unit 522. In one embodiment, the element 506 includes an RS encoding portion and an outer interleaving portion (not shown). In one embodiment, the video sequence 502 and the pixel interleaver 504 may belong to the MAC layer 208, and the remaining elements of the FIG. 5 system may belong to the PHY layer 206 (see FIG. 2). In one embodiment, the system 500 uses the data format of FIG. 4. Although four encoders are illustrated in FIG. 5, there may be more encoders (e.g., 8 or greater) or less encoders (e.g., 1 or 2) depending on specific applications.

The pixel interleaver 504 receives and interleaves a sequence of video pixels 502. The RS encoding portion of the element 506 performs RS encoding on the incoming data symbols, and the RS encoded symbols are further interleaved by the outer interleaving portion of the element 506. In one embodiment, the outer interleaving portion of the element 506 is a block interleaver. The parser 508 parses incoming data streams into the encoders 510-516. In one embodiment, the parser 508 is a switch or demultiplexer which parses data in a bit-by-bit or a group-by-group manner, where the group size is an arbitrary number. In one embodiment, each of the encoders 510-516 is a convolutional encoder. In one embodiment, the RS encoder/outer interleaver 506 and the convolutional encoders 510-516 together perform FEC described with respect to FIG. 2. In one embodiment, the encoders 510-516 are configured to provide unequal error protection (UEP) depending on the relative importance of incoming data bits. For example, the encoders 510 and 512 may encode MSB data and the encoders 514 and 516 may encode LSB data. In this example, the MSB encoding provides better error protection than the LSB encoding. In another embodiment, the encoders 510-516 are configured to provide equal error protection (EEP) for all incoming data bits. A description regarding the operation of parallel convolutional encoders in WiHD is provided in U.S. patent application (Attorney Docket Number: SAMINF.045A) entitled “System and method for digital communication using multiple parallel encoders,” concurrently filed as this application, which is incorporated by reference.

The multiplexer 518 combines the bit streams output from the encoders 510-516. In one embodiment, the multiplexer 518 is a bit-by-bit round-robin multiplexer. In another embodiment, the multiplexer performs a puncture cycle based multiplexing on the encoded bit streams. The detailed multiplexing operation can be found in U.S. patent application (Attorney Docket Number: SAMINF.041A) entitled “System and method for digital communication having puncture cycle based multiplexing scheme with unequal error protection (UEP),” concurrently filed as this application, which is incorporated by reference.

The interleaver/mapper/OFDM modulation 520 performs interleaving/mapping/OFDM modulation on the output of the multiplexer 518. In one embodiment, the OFDM modulation may include inverse Fourier Fast Transform (IFFT) processing. The beamforming and RF unit 522 performs beamforming and transmits the pixels to a WiHD video data receiver over the wireless channel 201 (see FIG. 2). In one embodiment, the WiHD video data receiver may include a plurality of parallel convolutional decoders corresponding to the plurality of parallel convolutional encoders. In one embodiment, a description regarding the pixel interleaver 504, the RS encoder/outer interleaver 506, the interleaver/mapper/OFDM modulation 520 and the beamforming and RF unit 522 is provided in “WirelessHD Specification Revision 0.1,” Jul. 12, 2006, which is incorporated herein by reference.

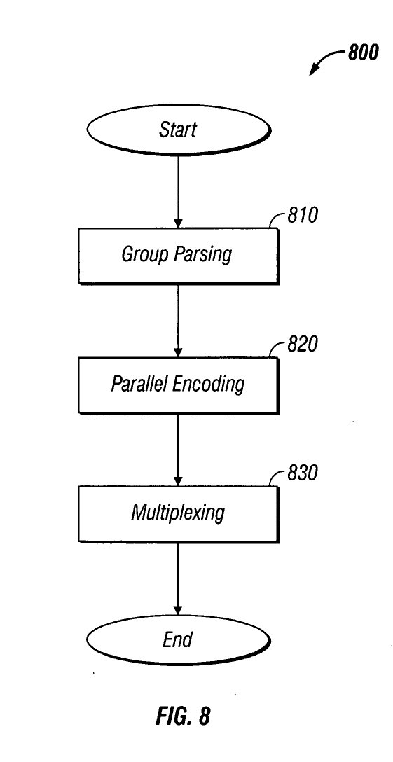

Referring to FIGS. 5-8, the operation of the parser 508 and encoders 510-516 will be described in more detail. FIG. 8 illustrates an exemplary flowchart which shows a wireless HD video transmitting procedure 800 according to one embodiment of the invention. In one embodiment, the transmitting procedure 800 is implemented in a conventional programming language, such as C or C++ or another suitable programming language. In one embodiment of the invention, the program is stored on a computer accessible storage medium at a WiHD transmitter, for example, a device coordinator 112 or devices (1-N) 114 as shown in FIG. 1. In another embodiment, the program can be stored in other system locations so long as it can perform the transmitting procedure 800 according to embodiments of the invention. The storage medium may comprise any of a variety of technologies for storing information. In one embodiment, the storage medium comprises a random access memory (RAM), hard disks, floppy disks, digital video devices, compact discs, video discs, and/or other optical storage mediums, etc.

In another embodiment, at least one of the device coordinator 112 and devices (1-N) 114 comprises a processor (not shown) configured to or programmed to perform the transmitting procedure 800. The program may be stored in the processor or a memory of the coordinator 112 and/or the devices (1-N) 114. In various embodiments, the processor may have a configuration based on Intel Corporation's family of microprocessors, such as the Pentium family and Microsoft Corporation's windows operating systems such as Windows 95, Windows 98, Windows 2000 or Windows NT. In one embodiment, the processor is implemented with a variety of computer platforms using a single chip or multichip microprocessors, digital signal processors, embedded microprocessors, microcontrollers, etc. In another embodiment, the processor is implemented with a wide range of operating systems such as Unix, Linux, Microsoft DOS, Microsoft Windows 2000/9x/ME/XP, Macintosh OS, OS/2 and the like. In another embodiment, the transmitting procedure 800 can be implemented with an embedded software.

In one embodiment, the transmitting 800 of FIG. 8 may be implemented with the “WirelessHD Specification Revision 0.1.” Depending on the embodiments, additional states may be added, others removed, or the order of the states changes in FIG. 8.

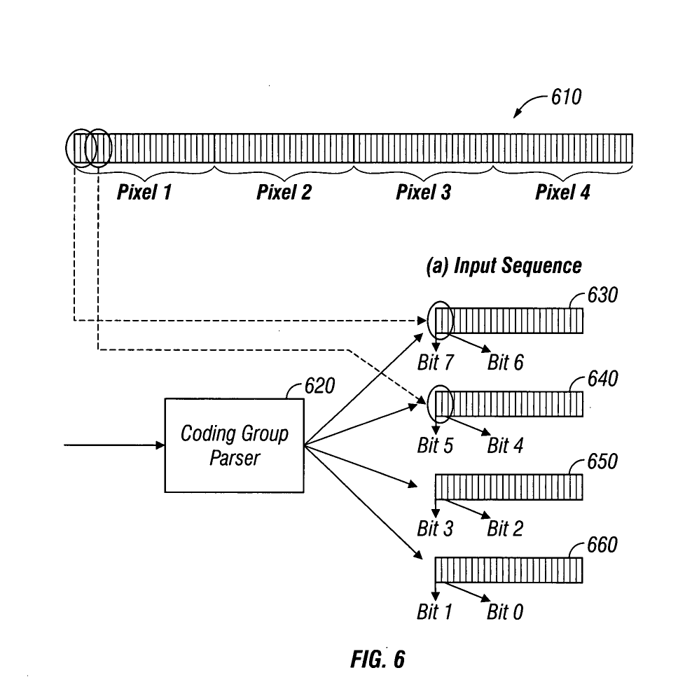

The input bit stream is group parsed by the parser 508 (810). In one embodiment, the parser 508 parses the received pixels bit-by-bit or by groups of bits. The group size depends on the input video format and/or specific applications. In one embodiment, the input video format is pixel by pixel, as shown in FIG. 6. In this embodiment, the parsing group can be as small as, for example, only 1 bit. In one embodiment, as shown in FIG. 6 (groups of two bits are shown), one pixel includes three colors, for example, red, blue and green, respectively, each having, e.g., 8 bits. The sequence that the parser 508 receives from the RS encoder/outer interleaver 506 includes a series of pixels as shown in FIG. 6. The system includes a coding group parser 620 which is one example of the parser 508. In one embodiment, the parser 620 parses the input sequence 610 starting from pixel 1 in the following order to the following encoders:

i) the first pair of two bits (bits 7 and 6, generally the most significant bits) of the red color to the first encoder 510.

ii) the second pair of two bits (bits 5 and 4) of the red color to the second encoder 512.

iii) the third pair of two bits (bits 3 and 2) of the red color to the third encoder 514.

iv) the fourth pair of two bits (bits 1 and 0, generally the least significant bits) of the red color to the fourth encoder 516.

v) the first pair of two bits (bits 7 and 6) of the blue color to the first encoder 510.

vi) the second pair of two bits (bits 5 and 4) of the blue color to the second encoder 512.

vii) the third pair of two bits (bits 3 and 2) of the blue color to the third encoder 514.

viii) the fourth pair of two bits (bits 1 and 0) of the blue color to the fourth encoder 516.

ix) the first pair of two bits (bits 7 and 6) of the green color to the first encoder 510.

x) the second pair of two bits (bits 5 and 4) of the green color to the second encoder 512.

xi) the third pair of two bits (bits 3 and 2) of the green color to the third encoder 514.

xii) the fourth pair of two bits (bits 1 and 0) of the green color to the fourth encoder 516.

Based on i)-xii), pixel 1 is completely parsed. In a similar way, the following pixels (pixels 2, 3, 4, . . . ) are continuously parsed. In one embodiment, each of the bit streams 630-660 corresponds to a single TDU.

As another example, it is assumed that a pixel has 10 bits per color. In one embodiment, the group size is 2, and five convolutional encoders (and five TDUs) are used. In this example, bits 9 and 8, bits 7 and 6, bits 5 and 4, bits 3 and 2, and bits 1 and 0 are parsed into first to fifth streams (not shown), respectively. In another embodiment, the group size can be less than 2 (e.g., 1 bit) or more than two (e.g., 5 bits), which would need different numbers of encoders (e.g., 10 encoders needed in the “1 bit” case and 2 encoders needed in the “5 bit” case).

As another example, if each color has 12 bits and the group size is 2, the parsed data would be grouped into six streams (not shown). In this example, the system may need six convolutional encoders each encoding a two-bit group. In another embodiment, the group size can be less than 2 (e.g., 1 bit) or more than two (e.g., 4 bits), which would need different numbers of encoders (e.g., 12 encoders needed in the “1 bit” case and 3 encoders needed for the “4 bit” case).

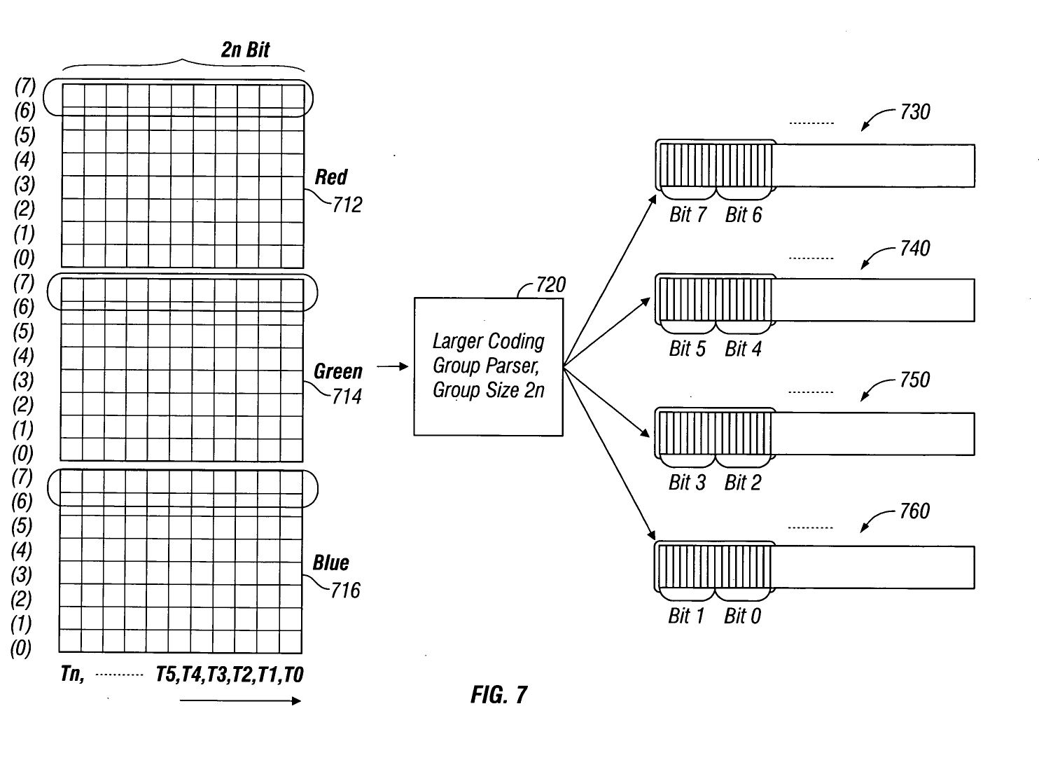

In another embodiment, the input video data is retrieved from memories. In one embodiment, three memories 712-716 include data for one color, e.g., red, green and blue, respectively, as shown in FIG. 7. In one embodiment, the memories 712-716 are located in the video sequence section 502 in FIG. 5. In another embodiment, the memories 712-716 are located at the source/starting point of the communication systems. In still another embodiment, the memories 712-716 are located in other element or location in the system of FIG. 5.

In another embodiment, more than three memories each including single-colored data may be used. In one embodiment, each color includes 2n bits, where n=1, 2, 3, . . . . The system includes a larger coding group parser 720 which is one example of the parser 508. The parser 720 parses the input sequence by “2n” bits (n=2, 3, 4, . . . ) so as to form bit streams 730-760. In one embodiment, “2n” can be 10-20. In one embodiment, each of the bit streams 730-760 corresponds to a single TDU. Each TDU is processed by a single convolutional encoder. It is assumed that the data bus width is m bits. If the group parser size is 1, meaning a bit by bit parser, then to parse 2n bits to each stream takes 2n cycles. On the other hand, if the group parser size is n=m, then to parse 2n bits to each stream takes only 2 cycles. In the above embodiment, the memory access time can be shortened if a group-by-group parsing is used instead of a bit-by-bit parsing. The group size n is variable, and depends on the actual systems.

The parsed bit streams are encoded in parallel in the encoders 510-516 (820). For example, the first to fourth encoders 510-516 encode the bit streams 630-660, respectively (see FIG. 6). Furthermore, the bit streams 730-760 are encoded by the encoders 510-516, respectively (see FIG. 7). In one embodiment, each of the encoders 510-516 encodes the incoming data as soon as it receives, and outputs the encoded data to the multiplexer 518 as soon as it encodes. In one embodiment, the number of encoders can vary depending on the input video data format and/or specific applications. The encoded data are multiplexed in the multiplexer 518 for further processing such as interleaving/modulation/beamforming (830).

One embodiment of the invention provides a frame format which is more efficient and significantly reduces decoding delay at a WiHD video data receiver. Another embodiment provides a group parser which allows for efficient convolutional encoding of the WiHD video data. According to at least one embodiment, the system provides the high transmission efficiency of the WiHD video data.

While the above description has pointed out novel features of the invention as applied to various embodiments, the skilled person will understand that various omissions, substitutions, and changes in the form and details of the device or process illustrated may be made without departing from the scope of the invention. For example, although embodiments of the invention have been described with reference to uncompressed video data, those embodiments can be applied to compressed video data as well. Therefore, the scope of the invention is defined by the appended claims rather than by the foregoing description. All variations coming within the meaning and range of equivalency of the claims are embraced within their scope.

What is claimed is:

1. A system for processing high definition video data to be transmitted over a wireless medium, the system comprising:
a parser configured to parse a received video data stream into a plurality of sub video data streams;
a plurality of encoders configured to encode in parallel the plurality of sub video data streams so as to create a plurality of encoded data streams; and
a multiplexer configured to multiplex the plurality of encoded data streams so as to create a multiplexed data stream.

2. The system of claim 1, further comprising an RF unit configured to transmit the encoded data streams to a wireless high definition video receiver which includes a plurality of parallel decoders.

3. The system of claim 2, wherein the receiver is a HDTV set or a projector.

4. The system of claim 1, wherein the parser is further configured to parse the received video data stream by groups of bits.

5. The system of claim 4, wherein the size of each group is 2 or greater.

6. The system of claim 1, wherein each of the plurality of encoders is a convolutional encoder.

7. The system of claim 6, wherein each convolutional encoder is configured to encode a single transmit data unit (TDU).

8. The system of claim 1, wherein the video data stream includes:
a packet header;
a medium access control (MAC) protocol data unit (MPDU) portion, wherein the MPDU portion includes a plurality of transmit data units (TDUs), wherein each TDU includes only data unit; and
a plurality of tail bits separately located from the MPDU portion, wherein the number of the tail bits is the same as or greater than that of the TDUs.

9. The system of claim 8, wherein the number of tail bits depends on the number of conventional encoders used in the parallel encoders and the chosen code.

10. The system of claim 8, wherein the packet header includes a preamble, a physical layer header (HRP header), an MAC header, a HCS (header check-sum), tail bits and pad bits for header.

11. The system of claim 1, wherein the system is implemented with one of the following: a set-top box, a DVD player or recorder, a digital camera, a camcorder and other computing device.

12. The system of claim 1, wherein the multiplexed data stream is uncompressed video signal.

13. A method of processing high definition video data to be transmitted over a wireless medium, comprising:
receiving a video data stream;
parsing the video stream into a plurality of sub video data streams;
convolutional encoding in parallel the plurality of sub video streams so as to create a plurality of encoded data streams; and
multiplexing the plurality of encoded data streams so as to create a multiplexed data stream.

14. The method of claim 13, wherein the video data stream is a series of pixels associated with red, blue and green colors.

15. The method of claim 14, wherein each pixel includes 24 bits with 8, 10 or 12 bits per color, and wherein the parsing is performed by groups of bits.

16. The method of claim 13, further comprising:
providing three memories associated with red, green and blue color data, respectively; and
retrieving each color data from the respective memory, wherein the parsing of the retrieved data is performed by groups of 2n bits for each color data, wherein n is a natural number.

17. The method of claim 13, wherein the convolutional encoding provides unequal error protection for incoming data bits depending on their relative importance.

18. The method of claim 17, wherein the convolutional encoding provides better error protection for most significant bits than least significant bits.

19. The method of claim 13, wherein the multiplexed data stream is uncompressed.

20. The method of claim 13, wherein the multiplexed data stream is transmitted over the wireless medium, received and decoded at a receiver.

21. One or more processor-readable storage devices having processor-readable code embodied on the processor-readable storage devices, the processor-readable code for programming one or more processors to perform a method of processing high definition video data to be transmitted over a wireless medium, the method comprising:
receiving a video data stream;
parsing the video stream into a plurality of sub video data streams;
convolutional encoding in parallel the plurality of sub video streams so as to create a plurality of encoded data streams; and
multiplexing the plurality of encoded data streams so as to create a multiplexed data stream, wherein the multiplexed data stream is uncompressed.

22. A system for processing high definition video data to be transmitted over a wireless medium, comprising:
means for receiving a video data stream;
means for parsing the video stream into a plurality of sub video data streams;
means for convolutional encoding in parallel the plurality of sub video streams so as to create a plurality of encoded data streams; and
means for multiplexing the plurality of encoded data streams so as to create a multiplexed data stream, wherein the multiplexed data stream is uncompressed.

23. A method of processing high definition video data to be transmitted over a wireless medium, comprising:
communicating a data frame having a format of:
a packet header;
a medium access control (MAC) protocol data unit (MPDU) portion,
wherein the MPDU portion includes a plurality of transmit data units (TDUs),
wherein each TDU includes only uncompressed video data unit; and
a plurality of tail bits separately located from the MPDU portion.

24. The method of claim 23, wherein the packet header includes a preamble, a physical layer header (HRP header), an MAC header, a HCS (header check-sum), tail bits and pad bits for header.

25. The method of claim 23, wherein the data frame further comprises at least one pad bit separately located from the MPDU portion.

26. The method of claim 23, wherein the number of the tail bits is the same as or greater than that of the plurality of TDUs.

27. The method of claim 23, wherein each TDU is configured to be encoded by an encoder before transmitting

28. The method of claim 27, wherein the encoder is a convolutional encoder.

29. The method of claim 28, wherein each TDU is processed by a single convolutional encoder.
